(19) United States
(12) Patent Application Publication
(10) Pub. No.: US 2008/0173766 A1
(43) Pub. Date: Jul. 24, 2008

(54) HIGH LIFT DISTRIBUTED ACTIVE FLOW CONTROL SYSTEM AND METHOD

(75) Inventor: David J. Manley, Huntington Beach, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: The Boeing Company

(21) Appl. No.: 11/828,437

(22) Filed: Jul. 26, 2007

Related U.S. Application Data
(62) Division of application No. 10/980,147, filed on Nov. 1, 2004.

(51) Int. Cl. B64C 21/00; B64C 21/06; B64C 21/04

(52) U.S. Cl. 244/208; 244/204

(57) ABSTRACT

The present invention is directed to a distributed active flow control (“DAFC”) system that maintains attached airflow over a highly cambered airfoil employed by an aircraft or other similar applications. The DAFC system includes a primary power source comprised of one or more aircraft engines, one or more power conversion units, and optionally, one or more auxiliary power units. The power conversion units are coupled to one or more aircraft engines for supplying power to a distribution network. The distribution network disperses power from the one or more power conversion units to active flow control units disposed within one or more aircraft flight control surfaces (e.g., the aircraft wing, the tail, the flaps, the slats, the ailerons, and the like). In one embodiment, an auxiliary power unit is included for providing a redundant and auxiliary power supply to the distribution network. In another embodiment, a back-up power source is provided in communication with the distribution network for providing an additional redundant power supply.

### CROSS-REFERENCE TO RELATED APPLICATIONS

The present application is a divisional of U.S. application Ser. No. 10/980,147, which was filed Nov. 1, 2004 and is entitled High Lift Distributed Active Flow Control System and Method. The disclosure of the referenced application is incorporated herein by reference in its entirety.

### BACKGROUND OF THE INVENTION

1. Field of the Invention

This invention relates generally to aircraft lift control systems, more particularly to a powered, lift-enhancing distributed active flow control system that operates safely despite the loss of a single aircraft engine.

2. Description of the Related Art

It has long been desirable to produce aircraft, especially jet aircraft, which are capable of taking-off and/or landing despite relatively short runway distances. Such aircraft are conventionally referred to as Short Take-Off and Landing (“STOL”) aircraft and include, for example, the Boeing YC-14, the McDonnell Douglas YC-15, and the USAF C-17 transport aircraft.

The primary challenge for STOL aircraft involves designing the aircraft to effectively achieve a shortened take-off distance. Typically, this is accomplished through increasing the aircraft's thrust, through increasing the aircraft's lift, or through some combination of both. Increasing thrust requires use of larger, more-powerful engines that add weight to the aircraft and consume greater quantities of fuel. As a result, STOL aircraft designers have primarily focused on increasing lift. Several lift-enhancing techniques currently exist. For example, lift may be increased relatively simply by providing a larger wing. Unfortunately, however, added wing size means added drag and weight during stable flight resulting in greater fuel consumption and slower cruising speeds. Other lift-enhancing techniques known in the art include coupled aero-propulsion designs, the use of lift-augmenters, tilt-wings, lift-fans and the like.

Coupled aero-propulsion involves increasing the velocity of the air directed over the wing during take-off. As lift is generally a function of air velocity—greater air velocity over the aircraft's wing generally produces greater lift. FIG. 1 provides an exemplary illustration of a coupled aero-propulsion system. The term “coupled aero-propulsion” generally refers to lift-enhancement systems where the aircraft's means for propulsion (i.e., the engines) are coupled to its ability to increase lift. Coupled aero-propulsion systems include externally blown flap systems, internally blown flap systems, and upper surface blown wings as known in the art. FIG. 1 depicts an internally blown flap system 10 according to the prior art wherein the aircraft engines 40 are positioned adjacent the leading edge of the wing 20. Auxiliary airflow ducts and valves 30 are provided for directing engine exhaust to blow over or under the wing flaps 25 as shown. As will be apparent to one of ordinary skill in the art, such “blown-wing” designs allow the wing 20 and wing flaps 25 to turn more air, thus, creating more lift.

Despite the lift improvements referenced above, coupled aero-propulsion systems include a number of drawbacks that significantly detract from their desirability. For example, maintenance issues plague many designs as they require internal ducting of hot exhaust gases and/or deflecting hot gases over the wing and flap surfaces. Coupled aero-propulsion designs that have the engines positioned adjacent the leading edge of the wing, tend to reflect the engine noise downward, toward the ground, resulting in higher community noise levels. Finally, coupled aero-propulsion designs present significant safety concerns. The FAA and Department of Defense require STOL aircraft to be capable of safe shortened take-off despite the loss of one of the aircraft's engines. As implicitly shown in FIG. 2, engine loss occurring in coupled aero-propulsion aircraft produces large asymmetric rolling and yawing moments. Notably, FAA regulations restrict aircraft from manually changing flap configurations in order to correct these asymmetric moments during initial engine-out. Instead, to gain FAA approval and overcome these asymmetries STOL aircraft using coupled aero-propulsion systems require complex, highly-reliable, flight-control systems that automatically change flap configurations upon initial engine-out. Additionally, aero-propulsion systems incorporate over-sized control surfaces into the tail and/or wing that resist asymmetric moments but also contribute added cost, weight, and drag to the aircraft.

Accordingly, it is desirable then to produce a high-lift aircraft system architecture that uses engine power to increase lift, however, does not produce large asymmetric moments upon loss of an engine. Further, it is desirable that the system be light-weight, easily maintainable, produce relatively less reflected engine noise than other high-lift systems, and provide an overall aircraft design that is comparable in cruise efficiency and cost to traditional non-STOL commercial aircraft.

### BRIEF SUMMARY OF THE INVENTION

The present invention is directed to a distributed active flow control (“DAFC”) system that maintains attached airflow over a highly cambered airfoil employed by an aircraft or other object that is similarly propelled by an engine through a fluid. Active flow control is synonymous with boundary layer control to one of ordinary skill in the art. Further discussion of non-aircraft applications is provided below and will be apparent to one of ordinary skill in the art in view of the foregoing discussion. Turning specifically to aircraft embodiments for illustration purposes only, the DAFC system includes a primary power source comprised of one or more aircraft engines, one or more power conversion units, and optionally, one or more auxiliary power units.

The power conversion units are coupled to one or more aircraft engines for supplying power to a distribution network. The distribution network disperses power from the one or more power conversion units to active flow control units (referred to herein as boundary layer control units) disposed within one or more aircraft flight control surfaces (e.g., the aircraft wing, the tail, the flaps, the slats, the ailerons, and the like). In one embodiment, an auxiliary power unit is included for providing a redundant and auxiliary power supply to the distribution network. In another embodiment, a back-up power source is provided in communication with the distribution network for providing an additional redundant power supply.

In one embodiment, the power conversion units are comprised of electrical generators. The electrical generators may be driven at least partially by one or more of the aircraft engines or alternatively, may be driven by one or more auxiliary power units. The electrical generators may be turbine-driven, ram-air driven or alternatively driven by the aircraft engine as known in the art. In still other embodiments, the boundary layer control units are arranged adjacent an aircraft flight control surface (e.g., a wing surface, flap, tail, etc.). In one embodiment, the boundary layer control units may comprise a pump, a suction port, and a blowing port that are configured to provide pressurized pneumatic jets to delay boundary layer separation of an air stream flowing over one or more aircraft flight control surfaces as defined above. In another embodiment, the boundary layer control units may comprise one or more oscillatory active flow control actuators that comprise energized, oscillatory jets for delaying boundary layer separation of the air stream flowing over one or more aircraft flight control surfaces.

In another embodiment, the DAFC system may include a controller in communication with the distribution network for engaging the boundary layer control units to selectively operate. In one embodiment, the boundary layer control units may operate continuously, or intermittently in a pulsed arrangement. In another embodiment, the boundary layer control units may be selectively engaged by the processor in response to input commands provided by a pilot or various onboard avionics.

Various embodiments of the present invention desirably increase lift by engaging boundary layer control units (i.e., active flow control units) to delay the onset of boundary layer separation when the wing, flaps, slats, and other flight control surfaces are deflected at angles beyond which they are conventionally unable to maintain attached (non-separated) airflow (e.g., a highly cambered airfoil configuration). The present invention does not require that the aircraft engines be mounted along the aircraft wingspan and, thus, does not produce large asymmetric moments upon loss of one of the aircraft's engines. Further, in various embodiments of the invention the aircraft engines are mounted near the rear of the aircraft to provide less reflected engine noise to the community below, as compared to prior art high-lift systems.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a coupled aero-propulsion high-lift system according to the known prior art;

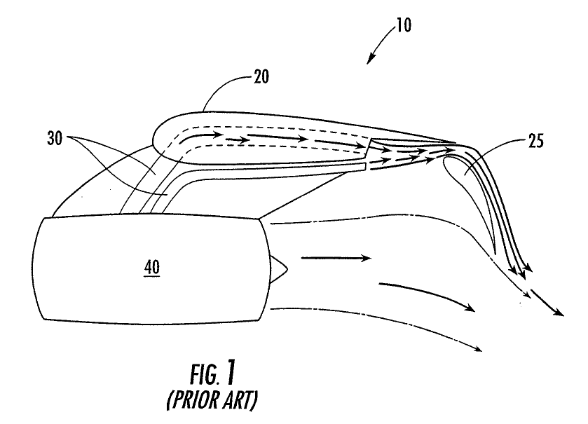

FIG. 2 is a top view of an aircraft employing a coupled aero-propulsion system (specifically, an internally blown high-lift system) according to the known prior art;

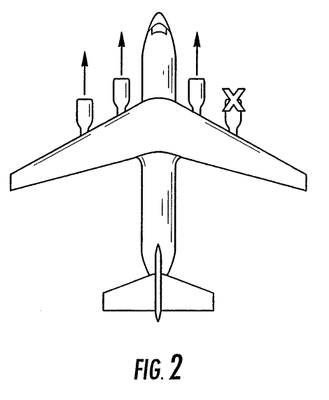

FIG. 3 is schematic illustration of a lift-enhancing distributed active flow control system in accordance with one embodiment of the present invention;

FIG. 4 is schematic illustration of a lift-enhancing distributed active flow control system in accordance with another embodiment of the present invention;

FIG. 5 is a side, schematic illustration of a plurality of boundary layer control units engaged by a distributed active flow control system according to one embodiment of the present invention; and

FIG. 6 is a perspective view of a plurality of boundary layer control (i.e., active flow control) units engaged by a distributed active flow control system according to one embodiment of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Various embodiments of the present invention are directed to powered distributed active flow control (“DAFC”) systems. As discussed in detail below, DAFC systems according to various embodiments of the invention include non-coupled, aero/propulsion high-lift systems that minimize the adverse effects of engine-out by reducing asymmetric moments. Although the forgoing discussion focuses primarily on DAFC systems configured for aircraft, it is noted that the DAFC systems described herein may be similarly applied to other applications where boundary layer separation control is desired for surfaces contacting fluids at angles beyond their inherent separation limit. More particularly, the present invention is applicable to objects propelled through fluids, which benefit from increased lift or reduced drag. For example, as will be apparent to one of ordinary skill in the art in view of the foregoing discussion, various embodiments of the present invention may be applied to spoilers, fins, or other moveable or non-moveable surfaces provided aboard submarines, high performance race cars, and the like.

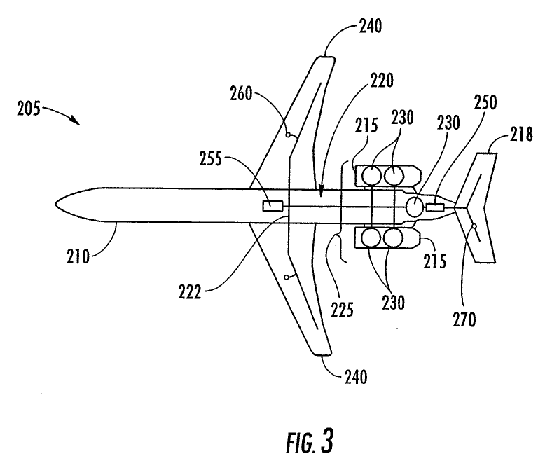

FIG. 3 illustrates a DAFC system 220 disposed aboard an aircraft 205 in accordance with one embodiment of the invention. The aircraft 205 includes a fuselage 210 supporting a wing section 240 and a tail section 218. In various embodiments, the DAFC system 220 includes a primary power source 225 comprising one or more engines 215, one or more power conversion units 230, and optionally, one or more auxiliary power units 250. In addition, various embodiments of the invention may include a back-up power source 255. In the depicted embodiment, the primary power source 225 comprises two engines 215, five power conversion units 230, and one auxiliary power unit 250 as shown. The depicted engines 215 are attached to the fuselage 210 just forward of the tail section 218; however, in other embodiments, the engines 215 may be affixed to the aircraft in a variety of locations as known in the art. For purposes of the following specification and appended claims the term “engine” or “aircraft engine” refers to those devices that are primary designed to provide thrust to an aircraft. Further, the term “flight control surface” refers to those surfaces within the wing, tail, flaps, slats, etc., that are configured to produce lift upon receiving an impinging airflow.

In various embodiments, the primary power source 225 and the back-up power source 255 are configured to supply power to a distribution network 225. The distribution network 225 disperses power from the primary and back-up power sources 225, 255 to boundary layer control units 260, 270 disposed on flight control surfaces within the aircraft's wing section 240, tail section 218, or some combination thereof. In various embodiments, the primary power source 225 and the back-up. power source 255 are electrical power sources that provide electrical energy to drive the DAFC system 220. In other embodiments, the DAFC system 220 may use pneumatic, hydraulic, or other similar means as part of the power conversion units and/or distribution network.

FIG. 3 provides a schematic illustration of an electrical DAFC system 220 according to one embodiment of the invention. In one embodiment the DAFC system 220 includes an electrical power distribution network 222 that disperses power to one or more electrically-driven, boundary layer control units 260, 270, located on one or more flight control surfaces of an aircraft. In the depicted embodiment, the flight control surfaces are provided on the aircraft wing section 240 and the aircraft tail section 218. In the depicted embodiment, the electricity needed to drive the flight control units 260, 270, is drawn from the primary power source 225. As described above, the primary power source 225 is comprised of one or more engines 215, one or more power conversion units 230, and optionally, one or more auxiliary power units 250 depending on the specific power and engine-failure redundancy requirements of a given DAFC system.

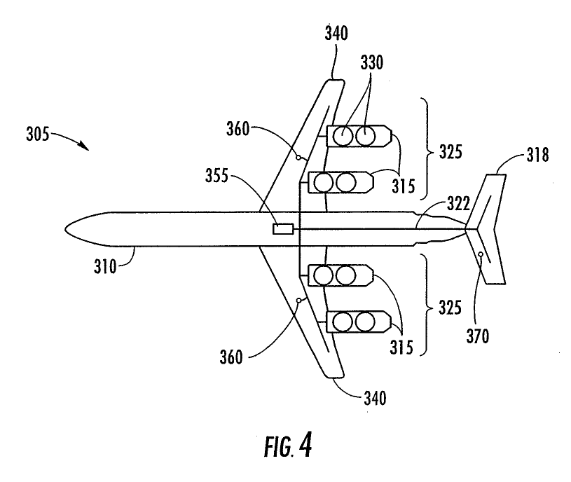

In various embodiments, the power conversion units 230 operate to convert energy from a form produced by the engines 215 or auxiliary power units 250 (e.g., mechanical energy) into a form sufficient to drive the boundary layer control units 260, 270 (e.g., electrical energy). In the depicted embodiment, the power conversion units 230 are comprised of electrical generators. FIG. 3 depicts two power conversion units 230 (electrical generators) coupled to each engine 215; however, in alternate embodiments (e.g., the DAFC system of FIG. 4), more or fewer power conversions units 230 may be provided per engine. Further, more or fewer engines may be provided to drive the power conversion units, thus, providing added engine failure redundancy.

In various embodiments, the power conversion units 230 may be comprised of rotary shaft-type generators configured to produce electricity upon rotation of the engine turbine, turbine shaft, or other similar engine component. In other embodiments, the power conversion units 230 may include high-pressure, air-driven, generators that rely on extracted high-pressure air from the engine to drive one or more rotors configured to produce electricity. In still other embodiments, other generators known in the art may be used.

In another embodiment, one or more power conversion units 230 may be driven by one or more auxiliary power units 250. In various embodiments, the auxiliary power units 250 are comprised of onboard, non-thrust producing motors or other similar devices that are primarily designed to drive the one or more power conversion units 230. This configuration stands in contrast to the aircraft's engines 215, which are designed primary to give the aircraft thrust. Accordingly, in various embodiments the auxiliary power units 250 may be specifically designed to efficiently produce electrical energy as will be apparent to one of ordinary skill in the art.

As noted above, the use of one or more auxiliary power units 250 is optional depending upon the requirements of a given aircraft application. More particularly, the decision as to whether to include one or more auxiliary power units 250 rests on a particular aircraft's power and redundancy requirements. For example, aircraft such as that depicted in FIG. 3 having only two engines 215 have fewer power conversion units 230 and, thus, produce less power and have less engine-failure redundancy than aircraft having four engines, such as, for example the DAFC system depicted in FIG. 4. As a result, depending on the power requirements of a particular aircraft, it may be necessary to provide one or more auxiliary power units 250 to supplement the power produced by a given DAFC system (e.g., FIG. 3), when it may not be necessary to supplement a differently configured DAFC system (e.g., FIG. 4). Regardless of whether an auxiliary power unit is used, DAFC systems according to the present invention are configured to provide sufficient power to engage one or more boundary layer control units 260, 270 during periods of high power demand, such as take-off and landing.

In various embodiments, the auxiliary power units 250 may be structured to possess a dedicated fuel source (not shown) comprising such fuels as gasoline, kerosene, hydrogen, hydrazine, and/or other similar fuels known in the art. As will be apparent to one of skill in the art in view of this disclosure, the size of the auxiliary power unit depends in large part, on the size of the aircraft, the size of the aircraft engines, and the power requirements of the specific boundary layer control units used. In one embodiment, one or more auxiliary power units may be configured to supplement the one or more power sources and provide auxiliary power to the boundary layer control units during periods of high power demand such as take-off and landing. Despite a relatively minor increase in weight, one or more auxiliary power units will likely remain desirable for many DAFC systems in view of the modern trend to provide increased in-flight or cruising electrical power to a variety of commercial and/or military aircraft. In various embodiments, the auxiliary power units and/or the other primary power source components may be configured to power the boundary layer control units during take-off and landing, and further configured to power other onboard systems (e.g., navigation, weapons systems, commercial passenger laptops, galley systems, and other onboard systems as will be apparent to one of skill in the art) during stable flight.

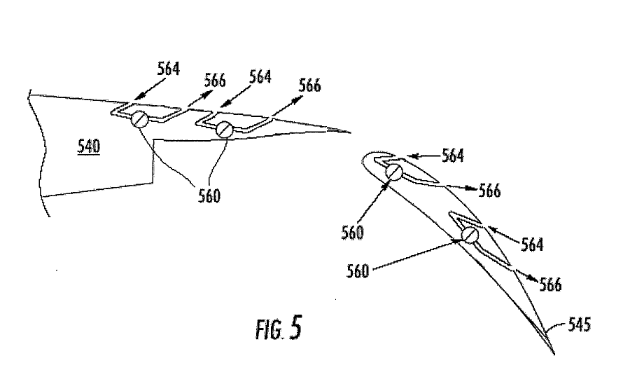

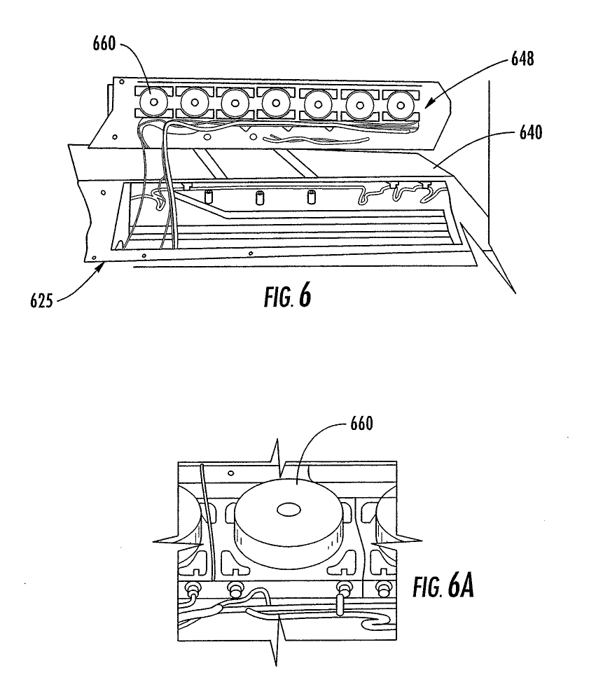

As referenced above, in various embodiments power is transmitted from the one or more conversions units 230 through a distribution network 225 to boundary layer control units 260, 270 provided in the wing and/or tail sections 240, 218. Particular boundary layer control unit embodiments are described in greater detail below with regard to FIGS. 5 and 6. In electrically-driven embodiments, the distribution network 225 may be comprised of a series of conductors (e.g., wires, contacts, connectors, etc.), wireless communication devices (e.g., transceivers, RF transponders and interrogators, magnetic or electromagnetic field producing devices, and the like), a combination of the two, or other similar means for transmitting electrical power and signals as known in the art. In yet another embodiment, the distribution network 225 may include a controller configured to receive input command signals from the pilot or other onboard systems. The controller (e.g., the flight control system computer) processes these signals, and employs logic to engage the flow control units to react accordingly.

As referenced above, DAFC systems according to various embodiments of the present invention are configured to increase lift and/or reduce drag. Unlike prior art systems, the present invention does not accomplish these goals by deflecting hot engine exhaust over or under the wing or tail sections. Instead, various embodiments of the present invention provide a redundant power distribution network to for driving boundary layer control units 260, 270 disposed within aircraft flight control surfaces to delay boundary layer separation, increase lift, and reduce drag.

The boundary layer of a given airflow is the relatively low-momentum air that flows immediately adjacent the surface of an object such as an airfoil (i.e., highly cambered airfoil configuration). By increasing the turning magnitude of the air stream traveling over an airfoil, a greater lift will be produced as understood by one of ordinary skill in the art. Unfortunately, however, increasing the turning magnitude of the airstream to achieve short take-off or landing performance, without simultaneously increasing thrust, conventionally results in boundary layer separation (i.e., air separation from the wing and/or flap leading edge) that substantially undermines lift and increases drag. In conventional non-STOL aircraft applications, boundary layer separation is moderately delayed through use of mechanical flaps and/or slats that alter the shape of the flow surface (e.g., the wing) during take-off and landing. The present invention aims to provide further delay of boundary separation than that which is achievable by traditional use of flaps, slats, and the like. In some applications, the increased lift attributable to this delayed boundary layer separation may be as high as 50 percent.

FIG. 3 depicts a back-up power source 255 in addition to the primary power source 225 discussed above. The back-up power source 255 provides a further redundant power supply in the event of a complete loss of the primary power source 225. In one embodiment, the back-up power source 255 is comprised of an electro-chemical device such as one or more batteries. In another embodiment, the back-up power source 255 may include a generator driven by a dedicated fuel source, a ram-air turbine, or other similar mechanism known in the art.

FIG. 4 illustrates yet another primary power source configuration in accordance with another embodiment of the present invention. Specifically, FIG. 4 depicts a primary power source 325 comprised of four engines 315, wherein each engine 315 drives one or more power conversion units 330 as shown. Each of the power conversion units 330 are provided in communication with the distribution network 322 and, thus, provide power to the one or more boundary layer control units 360, 370, disposed adjacent one or more flight control surfaces of the aircraft. As will be apparent to one of ordinary skill in the art in view of the above disclosure, the increased number of engines and power conversion units depicted within the DAFC system of FIG. 4 may provide sufficient power and engine-failure redundancy such that an auxiliary power unit (not shown) may not be necessary. In other embodiments, however, aircraft designers may wish to provide the depicted number of engines and power conversion units in combination with one or more auxiliary power units. More or fewer engines and power conversion units may be provided depending upon the aircraft system requirements as will be apparent to one of ordinary skill in the art in view of the foregoing disclosure.

As referenced above, in various embodiments of the present invention, one or more boundary layer control units are provided adjacent flight control surfaces of the aircraft to suppress boundary layer separation and thereby achieve STOL performance. In several embodiments of the present invention, the flow control units are electrically driven devices configured to discourage boundary layer separation. In one embodiment, as shown in FIG. 5, the boundary layer control units 560 include one or more electrically powered pneumatic pumps 562. The pumps 562 communicate with one or more suction ports 564 and one or more blowing ports 566 disposed along one or more flight control surfaces of the aircraft. In the depicted embodiment, the boundary layer control units 560 are provided along the upper surface of an aircraft's wing 540 and flap 545. In other embodiments, the boundary layer control units 560 may be provided along any surface of the aircraft where it is desirable to reduce boundary layer separation. Although not wishing to be bound by theory, the suction ports 564 of the depicted flow control units 560 remove boundary layer flow of low momentum while the blowing ports 566 push boundary layer flow, thereby discouraging boundary layer separation despite high flap deflections and high angles of attack. In the depicted embodiment, the suction ports 564 are positioned upstream of the blowing ports 566 for each control unit 560 as shown. In other embodiments, this configuration may be reversed such that the suction ports 564 are configured downstream of the blowing ports 566 (not shown). In various other embodiments, the boundary layer control units 560 may include one or more switches to accommodate continuous, pulsed, or selective operation for power conservation purposes.

In other embodiments, a variety of additional flow control units may be used in combination with, or alternative to, the suction/blowing flow control units referenced above. For example, in the embodiment depicted in FIG. 6, the electrical DAFC system drives a plurality of oscillatory flow control actuators 660 provided along the flight control surfaces of the aircraft. In the depicted embodiment, the actuators 660 are provided on the undersurface of a removable panel 648 disposed in the upper surface of an aircraft wing 640. The actuators 660 include a diaphragm portion (not shown) configured generally flush with the wing's upper surface in a rest position. FIG. 6A provides a detail illustration of an exemplary oscillatory flow control actuator. As known to one of skill in the art, the diaphragm is configured to oscillate at a selected frequency during take-off and landing to delay boundary layer separation. Once again, as with the suction/blowing boundary layer control units described above, the flow control actuators 660 may be configured for continuous, pulsed, or selective operation.

As will be apparent to one of ordinary skill in the art, various embodiments of the present invention provide a number of benefits over prior art coupled aero-propulsion systems. For example, DAFC systems according to the present invention achieve greater lift despite de-coupling the engines from the aircraft wing. In various embodiments, the engines may be removed from the wing and mounted along the fuselage forward of the tail section in a configuration that significantly reduces community noise and reduces roll and yaw moments produced should an engine become inoperable. As a result, unlike prior art high-lift systems, the DAFC system meets fail-safe system requirements of the FAA and Department of Defense.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A distributed active flow control system for an aircraft that is adapted for short take-off and landing operation, the system comprising:
a first power source;
an auxiliary power source;
a distribution network in communication with said first power source and said auxiliary power source; and
one or more boundary layer control units disposed proximate a flight control surface of the aircraft, wherein said one or more boundary layer control units are adapted to draw power from said first power source and said auxiliary power source through said distribution network, and wherein said one or more boundary layer control units are engaged to delay boundary layer separation of a flow proceeding over said flight control surface during take-off and landing operations.

2. The distributed active flow control system of claim 1, wherein said first power source comprises at least one engine and at least one power conversion unit, wherein said at least one engine and said at least one power conversion unit is in communication with said distribution network.

3. The distributed active flow control system of claim 1, wherein said first power source comprises a first engine coupled to a first power conversion unit, a second engine coupled to a second power conversion unit, and said auxiliary power unit provides power to said boundary layer control units during take-off and landing operations despite either the first or second engines become inoperable.

4. The distributed active flow control system of claim 1, wherein said boundary layer control units are disposed adjacent a plurality of flight control surfaces.

5. The distributed active flow control system of claim 4, wherein at least one of said plurality of flight control surfaces is comprised at least partially of an upper surface of an aircraft wing.

6. The distributed active flow control system of claim 4, wherein at least one of said plurality of flight control surfaces is comprised at least partially of an upper surface of an aircraft flap.

7. The distributed active flow control system of claim 4, wherein at least one of said plurality of flight control surfaces is comprised at least partially of an aircraft tail surface.

8. The distributed active flow control system of claim 4, wherein at least one of said plurality of flight control surfaces is comprised at least partially of an aircraft slat.

9. The distributed active flow control system of claim 1, further comprising a controller in communication with said distribution network for engaging said boundary layer control units to selectively operate during take-off and landing operations.

10. The distributed active flow control system of claim 1, further comprising a back-up power source in communication with said distribution network for providing back-up power to said boundary layer control units upon loss of said first power source.

11. The distributed active flow control system of claim 1, wherein said boundary layer control units comprise at least one of a pump, a suction port, and a blowing port, which are engaged to delay boundary layer separation of the flow proceeding over the flight control surface during take-off and landing operations.

12. The distributed active flow control system of claim 1, wherein said boundary layer control units comprise one or more oscillatory flow control actuators, which are engaged to delay boundary layer separation of the flow proceeding over the flight control surface during take-off and landing operations.
